(19) United States
(12) Patent Application Publication
(10) Pub. No.: US 2004/0152474 A1
(43) Pub. Date: Aug. 5, 2004

(54) Information providing system, apparatus, method and pervasive device relative to geographical location

(75) Inventors: Ying Chen, Beijing (CN); Fang Yan Rao, Beijing (CN); Xiu Lan Yu, Beijing (CN)

Correspondence Address: Rafael A. Perez-Pineiro, Intellectual Property Law Dept., IBM Corporation, P.O. Box 218, Yorktown Heights, NY, 10598, US

(73) Assignee: International Business Machines Corporation, Armonk, NY

(21) Appl. No.: 10/690,691

(22) Filed: Oct. 22, 2003

(30) Foreign Application Priority Data
Oct. 23, 2002 (CN) 02148058.3

(51) Int. Cl. H04Q 7/20

(52) U.S. Cl. 455/456.3; 455/456.1

(57) ABSTRACT

The invention relates to the information providing system, information providing device, pervasive device and the method for providing the subscribed service relative to geographical locations. The location information providing device generates a task relating to a subscription service request responsive to the subscription service request on a pervasive device sent from a requester, the pervasive receives the task from the location service information providing device, self-positions and calculates based on the location to execute the task to generate the subscribed information and transmits the generated subscribed information to the requester. The invention makes fully use of the resource of the pervasive device so that the loads among the location service information providing device, the network and the pervasive device included in the location service system are balanced.

### TECHNICAL FIELD OF THE INVENTION

The present invention relates to an information providing system, an information providing apparatus, a pervasive device and an information providing method, and more particularly, relates to an information providing system, an information providing apparatus, a pervasive device and an information providing method for providing subscription service information relative to a geographical location.

### BACKGROUND OF THE INVENTION

With the development of the network and the communication, the human beings depend, more and more, on the modern communicating tools to obtain prompt information. It becomes a hot issue in the art to provide the subscription service relative to locations to mobile users by means of Global Positing System (GPS).

FIG. 1 is a block diagram showing an information service system providing information relative to locations in the prior art.

Typically, a location service information providing device 105 receives the subscription service requests on the requestee 1, 2 or M, sent from the requester 1,2 or N, via a network 101. The requestee may be, for example, a pervasive device such as a mobile telephone or a PDA; the subscription service requests may be, for example, the request where the requestee i (1≦i≦M, i and M are positive integers)is in at certain time or during certain time period, sent by the requester j (1≦j≦N, j and N are positive integers); or the request relating to the special and/or temporal condition based on the location of the requestee i, such as when the requestee i is located at the gate of certain hotel. The requester may be the user holding the mobile telephone or the PDA; or the other users interested in the tracks of the users owning the requestees, such as the parents of their children, the taxi company that the taxi drivers belong to.

FIG. 2 is a functional block diagram showing a location service information providing device 105 for providing the subscribing service relative to a location. Typically, a location tracking and positioning unit 201, for example a GPS, detects the current location of the requestee i via a network 110. A location based information calculating unit 205 calculates to obtain the service information satisfying the request condition included in the location service request, based on the current location of the requestee i and the request condition. A location based transmitting unit 210 provides the calculated subscription service information to the corresponding requester j.

In the above prior art, the location service information providing device 105 needs to bear heavy burdens, such as tracking and positioning the requestee, calculating based on the positioned location information. In addition, the network loads are also increased because of the exchange of the positioning information between the location service information providing device 105 and the requestees, so that the performance of the whole system is aggravated. The situation will be come worse if the subscription service requests increase sharply.

The processing capabilities of the pervasive devices become more powerful but the cost thereof is decreased, with the development of the hardware of the load-in processor and the memory. Then many calculations may be performed in the pervasive devices, which otherwise are done in the service information providing device. Such a change does not increase the cost of the system as a whole. On the other hand, many pervasive devices may position themselves by self-positioning system, with the development of the positioning system such as the GPS.

The location based information providing system may be improved by considering the above techniques.

### SUMMARY OF THE INVENTION

To solve the above problems, one object of the invention is to provide an information providing system for providing the subscription service relative to a geographical location, in which a pervasive device can self-position, calculate based on the location positioned, and generate subscription information.

Another object of the invention is to provide an information providing device which provides the subscription service relative to a geographical location.

Another object of the invention is to provide a pervasive device which can self-position, calculate based on the location positioned, and generate subscription information.

Another object of the invention is to provide an information providing method for providing the subscription service relative to a geographical location, in which a pervasive device can self-position, calculate based on the location positioned, and generate subscription information.

To achieve the above objects, the invention provides an information providing system, an information providing device, a pervasive device and a method for providing the subscribed service relative to geographical location. The location information providing device generates a task relating to a subscription service request, in response to the subscription service request on a pervasive device sent from a requester; the pervasive receives the task from the location service information providing device, self-positions and calculates based on the location to execute the task to generate the subscribed information and transmits the generated subscribed information to the requester.

The present invention has an advantage that the location positioning and the related calculation usually executed by the location service information providing device are executed by the pervasive device, so that the load of the location service information providing device is reduced.

The present invention has another advantage that the location positioning and the related calculation usually executed by the location service information providing device are executed by the pervasive device, so that the information exchange between the location service information providing device and the pervasive device is reduced, that is, the information transmission in the network is decreased so that the load of the network is cut down.

The present invention has another advantage that the location positioning and the related calculation usually executed by the location service information providing device are executed by the pervasive device, so that the source of the pervasive device is fully utilized, and then the loads among the location service providing device, the network and the pervasive device are leveraged.

The present invention has another advantage that it can provide flexible subscription information to a requester, according to different subscription service request.

The object and the advantage of the invention will be more apparent by reference to the preferred embodiments in accompanying with the drawings.

### BRIEF DESCRIPTION OF THE DRAWINGS

FIG. 1 is a block diagram showing an information service system providing location based subscription service in the prior art;

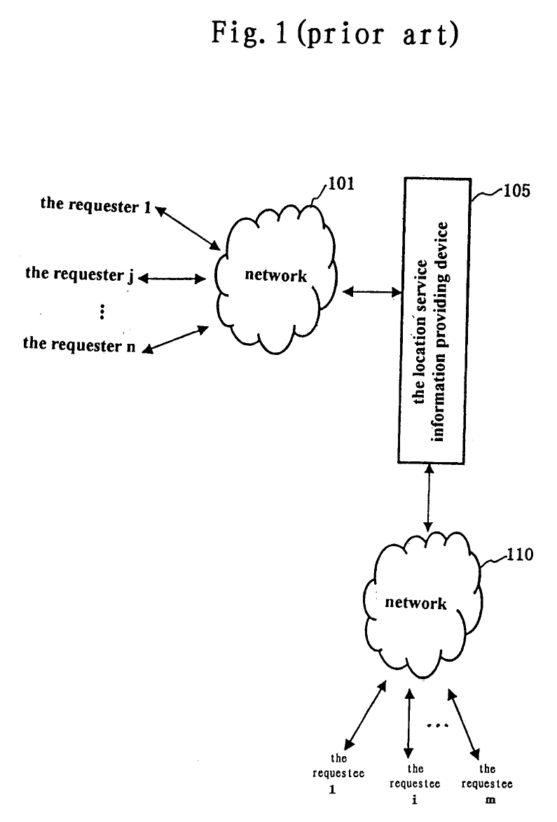

FIG. 2 is a functional block diagram showing a location service information providing device in the information service system in the prior art;

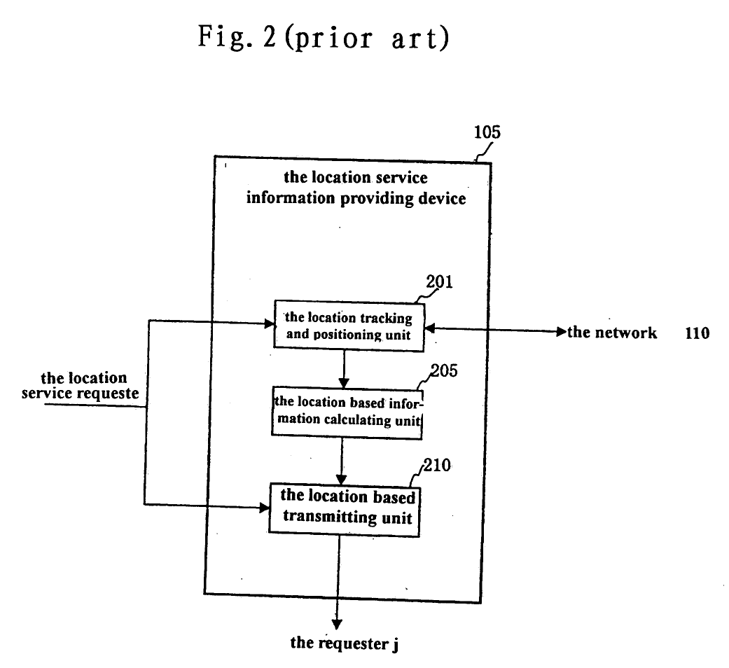

FIG. 3 is a block diagram showing an information service system providing location based subscription service according to the invention;

FIG. 4 is a functional block diagram showing a location service information providing device according to the invention;

FIG. 5 is a functional block diagram showing a pervasive device according to the invention;

FIG. 6 is a flow chart showing the process of handling the received subscription service request according to the location service information providing system;

FIG. 7 is a flow chart showing the process of handling the received subscription service request according to the location service information providing device;

FIG. 8 is a flow chart showing the process of the pervasive device;

FIG. 9 is a flow chart showing the process of the task application.

### DETAILED DESCRIPTION OF THE INVENTION

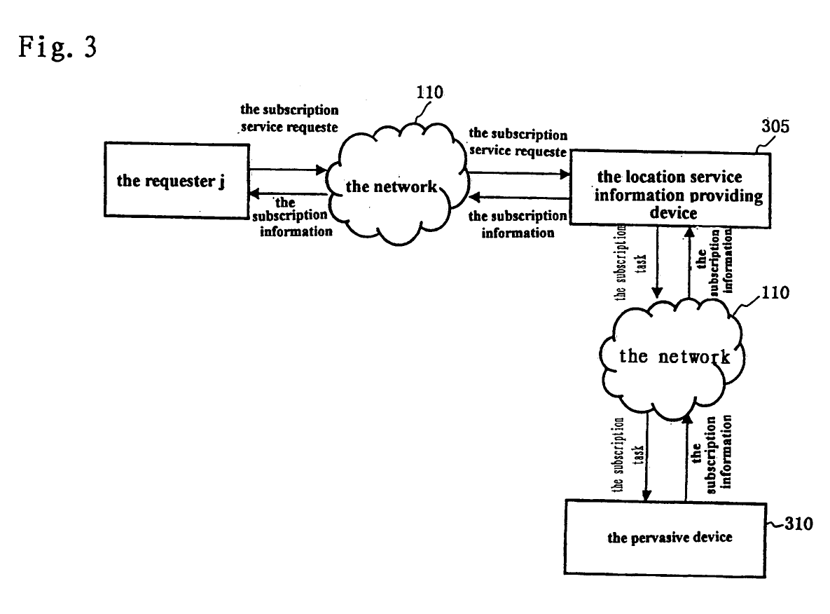

The information providing system for providing the subscription service relative to a location according to the invention will now be described, by referring to FIG. 3.

As shown in FIG. 3, the information service system according to the invention comprises a location service information providing device 305, which generates a task relating to a subscription service request, in response to a subscription service request based on a location of a pervasive device (also named a requestee) 310 sent from a requester J. The subscription information corresponding to the subscription service request may be generated, after the task is executed. The subscription service request include the spacial and/or temporal related condition(s)relating to location(s)(herein after named as trigger(s), the spacial and/or temporal related condition(s) relating to one location is named as one trigger), as well as the identifier of the pervasive device 310. It will describe how to generate a task in details in the later.

The pervasive 310 receives the generated task from the location service information providing device 305, executes the task, generates the subscription information corresponding to the subscription service request, and sends the generated subscription information to the requester j. It will describe the process of the pervasive device 310 in the later.

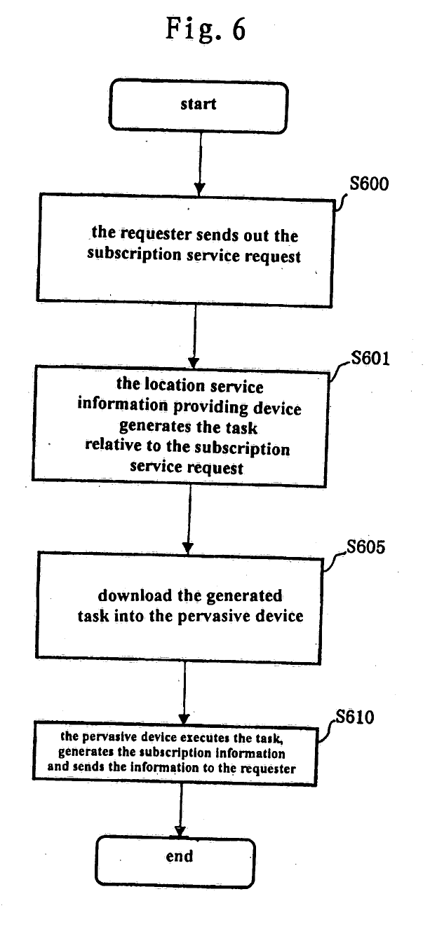

FIG. 6 is a flow chart showing the process of handling the received subscription service request according to the location service information providing system.

At step S600, the location service information providing device 305 receives the subscription service request based on the location of the pervasive device 310 sent from the requester j.

At step S601, the location service information providing device 305 generates the task relating to the subscription service request, in response to the subscription service request based on the location of the pervasive device 310 sent from the requester j.

Then, at step S605, the location service information providing device 305 downloads the generated task into the corresponding pervasive device 310, according to the identifier of the pervasive device 310.

At step S610, the pervasive device 310 executes the task, generates the subscription information corresponding to the subscription service request, and sends the generated subscription information to the requester j.

According to the information service system of the invention, the location positioning and the related calculation usually executed by the location service information providing device are executed by the pervasive device, so that the load of the location service information providing device is reduced.

Additionally, the location positioning and the related calculation usually executed by the location service information providing device are executed by the pervasive device, so that the information exchange between the location service information providing device and the pervasive device is reduced, that is, so that the load of the network is cut down.

The present invention fully utilizes the resource of the pervasive device, so that the loads among the location service providing device, the network and the pervasive device are leveraged.

It will be understood for those skilled in the art that the requestee is not limited to a pervasive device and all the terminals having the capability of self-positioning, calculating and networking may be regarded as the requestees, although the pervasive device is regarded as the requestee in the invention.

In FIG. 3, the subscription information sending from the pervasive device 310 to the requester j is transferred along the path of the pervasive device 310→the network 110→the location service information providing device 305→the network 101→the requester j. This transferring path is especially appropriated to the situation when the pervasive device 310 itself is not the terminal belonging to the requester j. however, when the pervasive device 310 itself is the terminal belonging to the requester j, the subscription information need not to be transferred along the path. The subscription information, in turn, may be presented to the requester j in the form of voice, text or image. Moreover, when pervasive device 310 itself is not the terminal belonging to the requester j, the subscription information may be sent to the requester j by the way of sending a short message to the terminal designated by the requester j from the pervasive device 310. The invention may utilize all the prior art for sending the subscription information to the requester j to realize the process of feeding back the subscription information.

In addition, Although two networks are used in, for example, in FIG. 3, the network 101 and the network 110 are used to represent the network connection between the requester j and the location service information providing device 305, and the network connection between the location service information providing device 305 and the pervasive device 310, respectively. It will be understood for the persons in the art that, the network 101 and the network 110 may be the same network, especially when the pervasive device 310 itself is the terminal belonging to the requester j, and the requester j and the pervasive 310 are located in the same place. In this situation, the requester j may input a subscription request through the pervasive device 310, and receive the subscription information through the pervasive device 310.

In addition, the requester j may input a subscription service request via an input interface not shown, which may be provided by the service provider running the location service providing device 305 and downloaded to the requester.

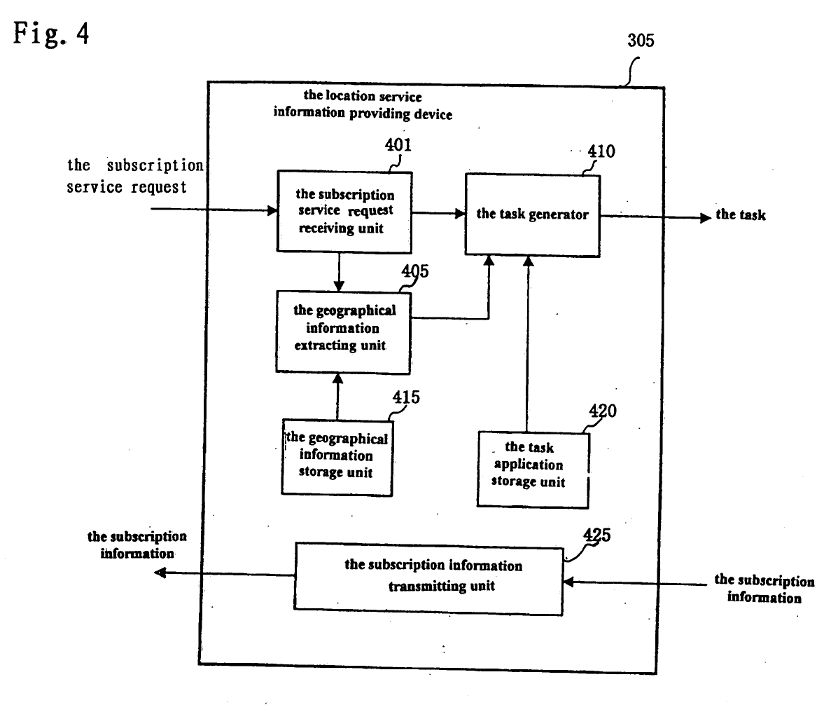

The operation of the location service information providing device according to the invention will be described in detail, by referring to FIG. 4.

FIG. 4 is a function block diagram of the location service information providing device according to the invention.

The location service information providing device 305 comprises a subscription service request receiving unit 401, a geographical information extracting unit 405, a task generator 410, a geographical information storage unit 415, a task application storage unit 420 and a subscription information transmitting unit 425.

The subscription service request receiving unit 401 receives the subscription service request from the requester j, specifies the data relative to the geographical location included in the subscription service request information based on the subscription service request information, such as the place name and the building name, and sends the specific geographical location data to the geographical information extracting unit 405. Further, the subscription service request receiving unit 401 sends the subscription service request to the task generator 410. It will be understood for the persons in the art that the subscription service request may be in the form of voice or text; and the operation of specifying the geographical location data may be implemented by known character recognizing, image recognizing or voice recognizing technique.

The geographical information storage unit 415 stores the spacial geographical location information within the range being able to be tracked and positioned by the tracking and positioning system inside the pervasive device 310. For example, the geographical information storage unit 415 stores the spacial geographical location information about the city A, if the range that can be tracked and positioned by the tracking and positioning system such as a GPS inside the pervasive device 310 is the city A. The spacial geographical location information may include various kinds of spacial geographical data, such as the travel sites location information, the traffic paths location information, the hotels location information and the shopping centers location information.

The embodiment is illustrated by using one pervasive device 310. However, the geographical information storage unit 415 may store the spacial geographical location information within the ranges being able to be tracked and positioned by the tracking and positioning systems inside the pervasive devices 310 respectively, if there are several pervasive devices 310 capable of receiving tasks from the location service information providing system according to the invention.

The geographical information extracting unit 405 extracts the spacial geographical information relating to the specified geographical location data from the geographical information storage unit 415, based on the specified geographical location data received from the subscription service request receiving unit 401.

The task application generation module storage unit 420 stores the task application generation modules for generating task applications. The task application generation modules may be those shared generation modules for generating individual task application based on one or more spacial and/or temporal related triggers generated from a subscription service request.

The task generator 410 generates one or more spacial and/or temporal related triggers, from the subscription service request received from the subscription service request receiving unit 401. The operation for generating the triggers may be implemented by known character recognizing, image recognizing or voice recognizing technique. In the invention, one trigger is relative to certain or uncertain location and the spacial and/or temporal related condition based on the location. For example, the subscription service request sent from a requester may include two triggers, one is when the requestee arrives at the hotel A, the other is where the requestee is at 12:00 AM.

The corresponding task application generation module(s) is/are called from the task application generation module storage unit 420. The module may be, for example, the module for generating the task based on spacial related trigger(s), the module for generating the task based on temporal related trigger(s) and the module for generating the task based on spacial and temporal related trigger(s). One or more task applications are generated based on the generated spacial and/or temporal related trigger(s), by using the task application generation module(s). The task applications, in essential, are the programs for generating the subscription information responding to the subscription service request of the requester when running. The task applications include the process for controlling when to detect the current geographical location where the pervasive device locates based on the trigger(s), and the process for generating the subscription information satisfying the spacial and/or temporal triggers by calculating based on the detected geographical location. The process of the task applications will be described in details later.

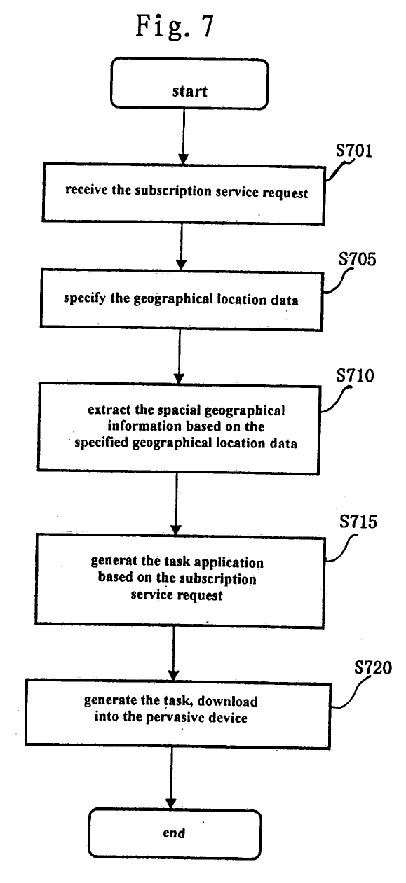

FIG. 7 is the flow chart showing the process to handle the received subscription service request by the location service information providing device.

At step S701, the subscription service request receiving unit 401 receives the subscription service request from the requester j.

At step S705, the subscription service request receiving unit 401 specifies the data relating to the geographical location such as the location name and the building name in the subscription service request information, and sends the specified geographical location data to the geographical information extracting unit 405.

At step S705, the subscription service request receiving unit 401 also sends the subscription service request to the task generator 410.

At step S710, the geographical information extracting unit 405 extracts the spacial geographical information relating to the specified geographical location data from the geographical information storage unit 415, based on the specified geographical location data received from the subscription service request receiving unit 401.

At step S715, the task generator 410 generates one or more spacial and/or temporal triggers, based on the subscription service request received from the subscription service request receiving unit 401, calls the corresponding task application generation module(s) from the task application generation module storage unit 420, and generates one or more task applications, according to one or more spacial and/or temporal triggers by utilizing the task application generation module(s).

At step S720, the task generator 410 generates a task, based on the generated task applications and the spacial geographical information extracted by the geographical extracting unit 405, and sends the task to the pervasive device 310 via the network 110.

According to another embodiment of the invention, the task generator 410 will executes the above steps several times to generate several tasks and sends them to the pervasive device 310 via the network 110, when several subscription service requests are sent to the same pervasive device 310 by one requester.

When there is a spacial requirement on the subscription service requests from the requester, for example, when the requester has the priorities on the response with respect to the several triggers or several subscription service requests, the task generator 410 also sets the controlling program for controlling the priorities of running the several task applications or sets other controlling program corresponding to the specific requirement when generating the tasks. The controlling program may be integrated into the task and sent to the pervasive device or separately sent to the pervasive device.

The subscription information transmitting unit 425 sends the subscription information received from the pervasive device 310 to the requester as needed. The subscription information transmitting unit 425 is employed when the pervasive device 310 itself is not the terminal belonging to the requester j.

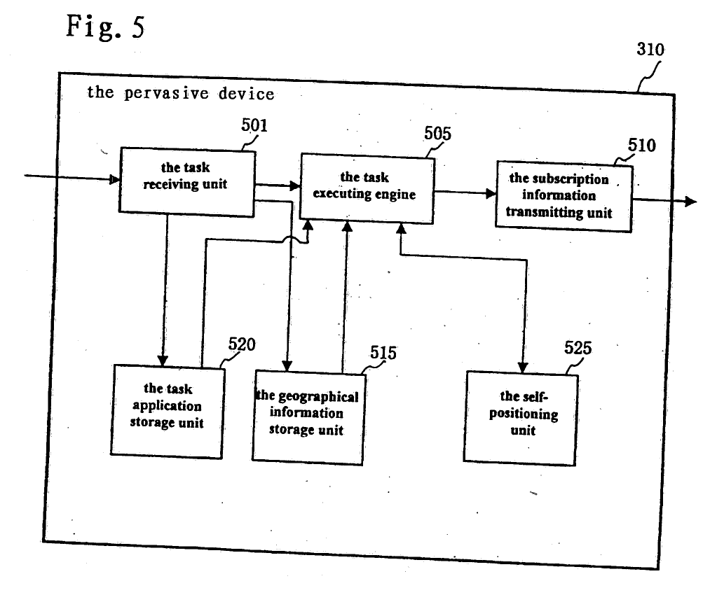

FIG. 5 is the functional block diagram of the pervasive device 310 according to the invention.

The pervasive device 310 comprises the task receiving unit 501, the task executing engine 505, the subscription information transmitting unit 510, the task application storage unit 520, the geographical information storage unit 515 and the self-positioning unit 525.

The task receiving unit 501 receives the task generated by the task generator 410 and downloaded from the location service information providing device 305 via the network 110, stores the task application included in the task into the task application storage unit 520 and stores the spacial geographical information included in the task in the geographical information storage unit 515. In addition, the task receiving unit 501 notifies the task executing engine 505 the message of receiving the task, and sends the controlling program to the task executing engine 505 when there is a controlling program.

The task executing engine 505 generally controls the execution of the task in the pervasive device. For example, it schedules the task application and coordinates with the location information providing device 305. It controls, in response to the message of receiving the task, to call the one or more task applications in the task application storage unit 520, and run the applications to generate the subscription information.

In addition, the task executing engine 505 also executes the controlling process in response to the special requirement of the requester based on the controlling program, when it receives the special controlling program.

The task application sends a request to the self-positioning unit 525 to detect the current geographical location of the pervasive device, when it is needed to detect the current geographical location of the pervasive device based on the trigger(s).

The self-positioning unit 525 detects the current geographical location of the pervasive device, in response to the request of the task application, and provides it to the task application. The self-positioning unit 525 may be any kind of devices capable of self-positioning, such as a GPS or a device receiving the positioning service from a third party.

According to another embodiment, the self-positioning unit 525 continuously self-positions, and stores the positioned information in a current geographical location storage unit (not shown) in the pervasive device, or updates the location information in the pervasive device, so that the most recently current location information may be obtained directly from the storage unit when the task application needs.

The task application calculates based on the current geographical location information provided by the self-positioning unit 525 to generate the subscription information satisfying the trigger(s).

The subscription information transmitting unit 510 sends the generated subscription information generated by the task applications to the requester, in the form of voice, image or text etc.

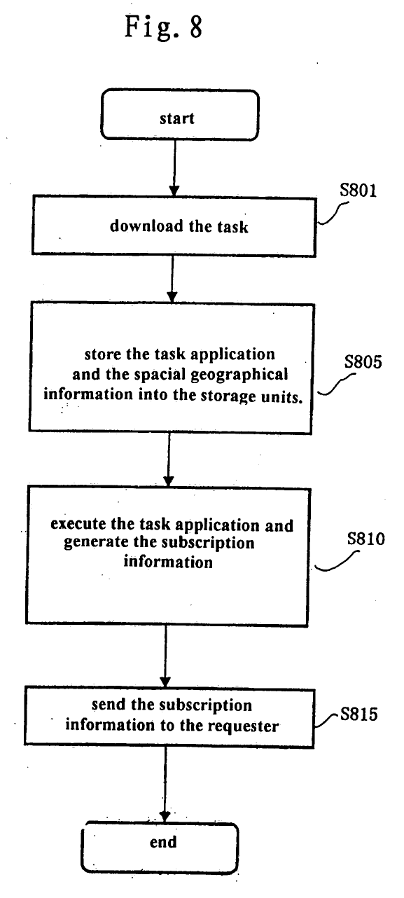

FIG. 8 is the flow chart showing the operation of the pervasive device.

At step S801, The task receiving unit 501 downloads the task generated by the task generator 410 from the task generator 410 of the location service information providing device 305 via the network 110.

At step S805, the task receiving unit 501 stores one or more task applications included in the task into the task application storage unit 520 and stores the spacial geographical information included in the task in the geographical information storage unit 515. In addition, the task receiving unit 501 notifies the task executing engine 505 the message of receiving the task and/or the controlling program.

At step S810, the task executing engine 505 controls, in response to receiving the message and/or the controlling program to call the one or more task applications in the task application storage unit 520, and run the applications to generate the subscription information.

At step S815, the subscription information transmitting unit 510 sends the subscription information generated by the task application(s) to the requester.

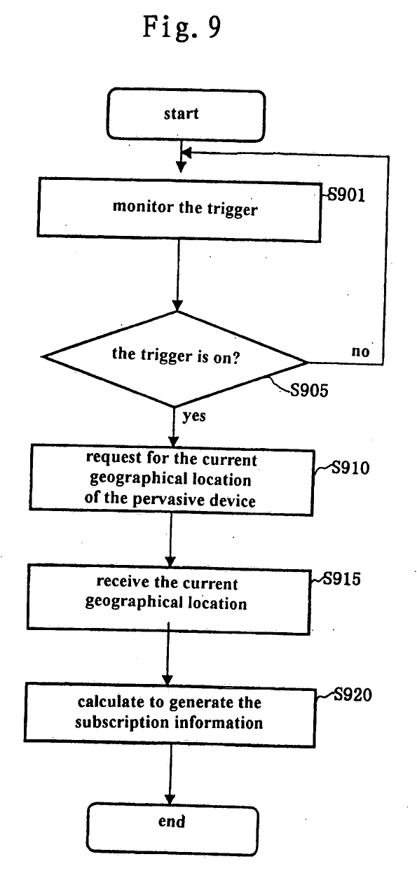

FIG. 9 is the flow chart of a task application.

At step S901, the task application monitors the trigger. At step S905, it detects whether or not the trigger is on. And if it is needed to detect the current geographical location of the pervasive device, it proceeds to step S910. At this step, a request is sent to the self-positioning unit 525 to detect the current geographical location of the pervasive device. At setp S915, it receives the current geographical location of the pervasive device detected by the self-positioning unit 525 in response to the request of the task application. At step S920, the task application calculates based on the current geographical location information to generate the subscription information satisfying the trigger.

The invention has been described with reference to the embodiments and the drawings which are not used to limit the invention. And the invention can be modified and improved without departing the spirit and the scope of the claims.

What is claimed:

1. A location service information providing system including at least one requester and at least one requestee, the system providing subscribed information for one of said at least one requester, in response to a subscription service request based on the location of one of said at least one requestee sent from one of said at least one requester,
said system comprising a location service providing device for generating a task relating to the subscription service request, in response to the subscription service request based on the location of said one of said at least one requestee sent from said one of said at least one requester,
said one of said at least one requestee receiving the task from said location service providing device, executing the task, generating the subscribed information responding to the subscription service request, and sending the generated subscribed information to said one of said at least one requeser.

2. The location service information providing system according to claim 1,
said location service information providing device comprising:
subscription service request receiving means, for receiving the subscription service request from said one of said at least one requester;
geographical information storage means, for storing the spacial geographical location information within the range where said at least one requestee that can be located;
task application generation module storage means, for storing one or more task application generation modules for generating task applications;
geographical information extracting means, for extracting the spacial geographical information relating to the geographical information specified from the subscription service request, from said geographical information storage means;
task generator, for generating one or more task applications for generating the subscribed information relative to the geographical location information, according to one or more triggers included in the subscription service request and for triggering the generating the subscribed information relative to the geographical location information, by utilizing the task application generation modules stored in said task application generation module storage means;
said task generator generating a task based on the generated task application(s) and the geographical information extracted by said geographical information extracting means, and transmitting the task to said one of said at least one requestee.

3. The location service information providing system according to claim 2,
said one of said at least one requestee comprising:
task receiving means, for receiving the task from said location service information providing device;
task application storage means, for storing the task application(s) included in the task;
geographical information storage means, for storing the spacial geographical information included in the task;
task executing engine, for controlling, in response to the received task by said task receiving means, the running of the task application(s) stored in said task application storage means to generate the subscribed information;
self-positioning means, for providing the current geographical location information of said one of said at least one requestee for the task application(s);
subscribed information transmitting means, for sending the subscribed information generated by the task application(s) to said one of said at least one requester.

4. The location service information providing system according to claim 3,
said location service information providing device further comprising subscribed information transmitting means for transmitting the subscribed information received from said one of said at least one requestee to said one of said at least one requester.

5. The location service information providing system according to any one of claims 2 to 4,
the one or more triggers being spacial and/or temporal related conditions relating to the specified geographical location.

6. The location service information providing system according to claim 5,
said task generator further generating a control program for controlling the task application(s) based on the special requirement included in the subscription service request, and transmitting said control program to said one of said at least one requestee.

7. The location service information providing system according to any one of claims 1 to 4,
said one of said at least one requestee being a pervasive device.

8. The location service information providing system according to claim 3, said self-positioning means being a GPS system.

9. A location service information providing device, for generating a task based on a location of a requestee for a requester, in response to the subscription service request based on the location of the requestee sent from the requester,
said location service information providing device comprising:
subscription service request receiving means, for receiving the subscription service request from said requester;
geographical information storage means, for storing the spacial geographical location information within the range where said requestee is that can be located;
task application generation module storage means, for storing one or more task application generation modules for generating task applications;
geographical information extracting means, for extracting the spacial geographical information relating to the geographical information specified from the subscription service request, from said geographical information storage means;
task generator, for generating one or more task applications for generating the subscribed information relative to the geographical location information, according to one or more triggers included in the subscription service request and for triggering the generating the subscribed information relative to the geographical location information, by utilizing the task application generation modules stored in said task application generation module storage means;
said task generator generating a task based on the generated task application(s) and the geographical information extracted by said geographical information extracting means, and transmitting the task to said requestee.

10. The location service information providing device according to claim 9,
said location service information providing device further comprising subscribed information transmitting means for transmitting the subscribed information received from said requestee to said requester.

11. The location service information providing device according to claim 9 or 10,
the one or more triggers bejing spacial and/or temporal related conditions relating to the specified geographical location.

12. The location service information providing device according to claim 11,
said task generator further generating a control program for controlling the task application(s) based on the special requirement included in the subscription service request, and transmitting said control program to said requestee.

13. A pervasive device, for providing the subscribed information based on the location of the pervasive device, in response to the subscription service request based on the location of the pervasive device sent from a requester, comprising,
task receiving means for receiving a task from a location service information providing device;
task application storage means for storing the task application(s) included in the task;
geographical information storage means for storing the spacial geographical information included in the task;
task executing engine for controlling, in response to the received task by said task receiving means, the running of the task application(s) stored in said task application storage means to generate the subscribed information;
self-positioning means for providing the current geographical location information of said pervasive device for the task application(s);
subscribed information transmitting means for sending the subscribed information generated by the task application(s) to said requester,
wherein the spacial geographical information is extracted from spacial geographical information storage means by the location service information providing device, based on the geographical location data specified from the subscription service request;
wherein the task application(s) for generating the subscribed information relative to the geographical location information is generated by said location service information providing device, according to one or more triggers included in the subscription service request and for triggering the generating the subscribed information relative to the geographical location information, and wherein
said task includes said spacial geographical information and the task application(s).

14. The pervasive device according to claim 13,
the task further including a control program for controlling the task application(s) generated by said location service information providing device, based on the special requirement included in the subscription service request.

15. The pervasive device according to claim 13 or 14,
said self-positioning means is a GPS system.

16. A location service information providing method, for providing subscribed information based on the location of one of at least one request for one of at least one requester, in response to a subscription service request based on the location of one of at least one requestee sent from said one of said at least one requester, comprising the steps:
a location service providing device generating a task relating to the subscription service request, in response to the subscription service request based on the location of said one of said at least one requestee sent from said one of said at least one requester,
said one of said at least one requestee receiving the task from said location service providing device, executing the task, generating the subscribed information responding to the subscription service request, and sending the generated subscribed information to said one of said at least one requeser.

17. The location service information providing method according to claim 16, the step of said location service information providing device generating the task further comprising the steps of,
receiving the subscription service request from said one of said at least requester;
extracting the spacial geographical information relating to the specified geographical location, from geographical information storage means storing the spacial geographical location information within the range where said at least one requestee can be located, according to the geographical location data specified from the subscription service request;
generating one or more task applications for generating the subscribed information relative to the geographical location information, according to one or more triggers included in the subscription service request and for triggering the generating the subscribed information relative to the geographical location information;
generating a task based on the generated task application(s) and the extracted geographical information, and transmitting the task to said one of said at least one requestee.

18. The location service information providing method according to claim 17, said step of said one of said at least one requestee executing the task further comprising the steps:
receiving the task from said location service information providing device;
in response to the received task, controlling the running of the task application(s) to generate the subscribed information;
sending the subscribed information generated by the task application(s) to said one of said at least one requester.

19. The location service information providing method according to claim 17, further comprising the step of:
said location service information providing device transmitting the subscribed information received from said one of said at least one requestee to said one of said at least one requester.

20. The location service information providing method according to claim 17 or 18,
the one or more triggers being spacial and/or temporal related conditions relating to the specified geographical location.

21. The location service information providing method according to claim 20, further comprising the step of:
said location service information providing device further generating a control program for controlling the task application(s) based on the special requirement included in the subscription service request, and transmitting said control program to said one of said at least one requestee.

22. The location service information providing method according to claim 20, said controlling step responsive to the received task further comprising the steps of:
monitoring the trigger(s);
sending a request for detecting the current geographical location of said one of said at least one requestee, to a self-positioning means, when the trigger(s) is/are on so as to detect the current geographical location of said one of said at least one requestee;
receiving the current geographical location of said one of said at least one requestee detected by said self-positioning means; and
calculating so as to generate the subscribed information based on the current geographical location of said one of said at least one requestee provided by said self-positioning means.

23. The location service information providing method according to any one of claims 16 to 19,
said one of said at least one requestee being a pervasive device.

24. The location service information providing method according to claim 18, said self-positioning means being a GPS system.

25. A method for generating a task based on a location of a requestee for a requester, in response to the subscription service request based on the location of the requestee sent from the requester, comprising the steps of:
receiving the subscription service request from said requester;
extracting the spacial geographical information relating to the specified geographical location, from geographical information storage means storing the spacial geographical location information within the range where said requestee can be located, according to the geographical location data specified from the subscription service request;
generating one or more task applications for generating the subscribed information relative to the geographical location information, according to one or more triggers included in the subscription service request and for triggering the generating the subscribed information relative to the geographical location information;
generating a task based on the generated task application(s) and the extracted geographical information, and transmitting the task to said requestee.

26. The method for generating a task according to claim 25, further comprising the step of:
said location service information providing device transmitting the subscribed information received from said requestee to said requester.

27. The method for generating a task according to claim 25,
the one or more triggers being spacial and/or temporal related conditions relating to the specified geographical location.

28. The method for generating a task according to any one of claims 25 to 27, further comprising the step of:
said location service information providing device further generating a control program for controlling the task application(s) based on the special requirement included in the subscription service request, and transmitting said control program to said one of said at least one requestee.

29. A location service information providing method in a pervasive device, for providing the subscribed information based on the location of the pervasive device, in response to the subscription service request based on the location of the pervasive device sent from a requester, comprising the steps of:
receiving a task from a location service information providing device, the task including one or more task application and the special geographical location information;
performing control, in response to the received task, so as to run the task application(s) to generate the subscribed information;
sending the subscribed information generated by the task application(s) to said requester,
wherein the spacial geographical information being extracted from spacial geographical information storage means by the location service information providing device, based on the geographical location data specified from the subscription service request; and
wherein the one or more task applications for generating the subscribed information relative to the geographical location information is generated by said location service information providing device, according to one or more triggers included in the subscription service request and for triggering the generating the subscribed information relative to the geographical location information.

30. The location service information providing method according to claim 29, said step of controlling responsive to the received task comprising the steps of:
monitoring the trigger(s);
sending a request for detecting the current geographical location of said requestee, to a self-positioning means, when the trigger(s) is/are on so as to detect the current geographical location of said requestee;
receiving the current geographical location of said requestee detected by said self-positioning means;
calculating so as to generate the subscribed information based on the current geographical location of said requestee provided by said self-positioning means.

31. The location service information providing method according to claim 29 or 30, said self-positioning means being a GPS system.
